(19) United States
(12) Patent Application Publication
(10) Pub. No.: US 2025/0305558 A1
(43) Pub. Date: Oct. 2, 2025

(54) Ball and DoubleRing

(71) Applicant: Alec Mead Rogers, Portland, OR (US)

(72) Inventor: Alec Mead Rogers, Portland, OR (US)

(21) Appl. No.: 18/621,087

(22) Filed: Mar. 28, 2024

(51) Int. Cl. F16G 11/14

(52) U.S. Cl. CPC F16G 11/146

(57) ABSTRACT

The Ball and DoubleRing are two parts of an invention that is designed to fasten one section of cord to another. The Ball consists of a spherical device with two passages and an intervening catch that can secure a cord. The DoubleRing consists of two rings that are statically attached to one another, each of which can be attached to a ball or to a section of cord. For example, a Bind is a ring with three passages, two of which allow a binding turn of cord to emerge from the face of the ring and a third which allows that cord to travel under the binding turn.

### BACKGROUND

Numerous outdoor and cycling activities require fastening gear to various other objects. For example, fasteners are used as methods of closure or attachment by lines tied to tents, bags tied to the rack of a bicycle, or personal items such as belts, backpacks and various bags. Many of those fasteners use ropes, strings, or cords whose length can be dynamically adjusted by tying a knot at different locations. However, fastening cords by tying knots requires more time and expertise than using a mechanical device such as a rope tensioner or a quick-release buckle. Such mechanical knots have additional benefits such as rapidly releasing and attaching the objects to which they are tied, easily tightening a cord that is under a load, and identifying the security of a cord.

Several existing designs achieve these ends with quick-release buckles that attach two flat nylon straps to one another. Many of those designs allow the user to tension or take up slack in one or both of those straps. The device described here is similar in that it supports both functions, i.e. quick attachment/release and adjustable tensioning.

The invention described here is designed to attach ropes or cords (such as paracord) to one another. This invention also addresses several additional requirements:
The device must be able to rapidly attach and detach two cords.
The device must be able to take up slack and apply tension to a cord.
The device must be able to attach to the midsection of a cord that is already in use.
The device must be able to hold a section of cord while permitting that cord to travel freely.

### BRIEF DESCRIPTION OF DRAWINGS

FIG. 1: Ball and LoopBind

Shows a single cord attached to a Ball and a LoopBind, which can be quickly attached or detached by inserting or removing the Ball from the Loop and can be tensioned by pulling on the end of cord extending from the Bind.

FIG. 2: The Ball

Shows cross-section, front, top, and side views of the Ball, which consists of an oblong sphere with two passages for a cord and an intervening recessed catch that can securely attach that cord.

FIG. 3: The Ball Attached to a Loop

Shows the Ball threaded through a Loop, which visually demonstrates that the oblong spherical shape of the Ball permits attachment to the Loop only when perpendicular to its face.

FIG. 4: Ball Locked to Ring by Cord

Shows a Ball with a dangling end of cord threaded through a Loop. Due to the fit of the Ball to the Loop, the Ball cannot be detached from the Loop without first passing the dangling cord.

FIG. 5: The DoubleBall

Shows front, top, and bottom views of the DoubleBall, which contains four passages and and enclosed space that can contain a knot formed in the ends of two cords.

FIG. 6: The Four Variations of the Ring

Shows the four variations of the ring: the Loop (which attaches to a Ball), the Cleat (to which a cord can be tied), the Bind (which tensions a cord), and the Eyelet (which encircles a cord).

FIG. 7: The DoubleLoop

Shows top, side, and front views of the DoubleLoop, which is a kind of DoubleRing that consists of two Loops and can therefore bind two Balls together.

FIG. 8: The LoopBind

Shows top, side, and front views of the LoopBind, which consists of a Loop and a Bind (the Bind is a ring with three passages that allows a cord to bind itself).

FIG. 9: The LoopBind Attached to a Cord

Shows the LoopBind attached to a cord, and illustrates how the bind created by the cord allows that cord to be pulled or tensioned exclusively in one direction.

FIG. 10: The LoopCleat

Shows top, side, and front views of the LoopCleat, which attaches the Loop to a cord with a ring-shaped horn cleat.

FIG. 11: The LoopEyelet

Shows top, side, and front views of the LoopEyelet, which attaches the Loop to a section of cord and allows the cord to travel freely.

FIG. 12: The DoubleBind

Shows top, side, and front views of the DoubleBind, which consists of two Binds or rings with three passages each.

FIG. 13: The BindCleat

Shows top, side, and front views of the BindCleat, which consists of a Bind that tensions a cord and a Cleat to which a second section of cord can be tied.

FIG. 14: The BindEyelet

Shows top, side, and front views of the BindEyelet, which consists of a Bind that tensions a cord against a freely-traveling section of cord encircled by the Eyelet.

FIG. 15: The DoubleCleat

Shows top, front, and side views of the DoubleCleat, which consists of two semicircular horn cleats and allows two cord midsections to be attached to each other.

FIG. 16: The CleatEyelet

Shows top, front, and side views of the CleatEyelet, which consists of a semicircular horn cleat attached to an Eyelet.

FIG. 17: The DoubleEyelet

Shows top, front, and side views of the DoubleEyelet, which consists of two attached eyelets, each of which can slide freely along a cord.

FIG. 18: The DoubleBind with a Shared Central Hole

Shows a DoubleBind which is comprised of two rings with three passages, wherein the central passage is shared between the rings.

FIG. 19: The BullsEye

Shows top, front, and side views of the BullsEye, which is a round device with radial cord passages that changes the configuration of the binding turns of cord when the device is turned.

FIG. 20: Turning the BullsEye

Shows a BullsEye in unturned (top) and turned (bottom) configurations, which illustrates that the binding turns cord of can be released by turning the BullsEye clockwise.

FIG. 21: Open BullsEye

Shows a BullsEye whose side passages are open to the exterior of the ring.

### DESCRIPTION

### The Ball

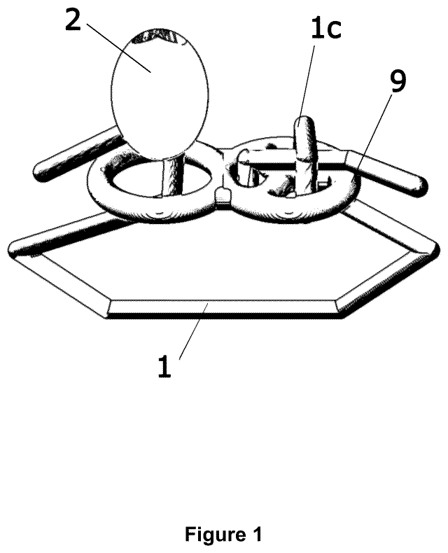

The Ball and DoubleRing is an invention comprising several versions of a device that can be used to fasten one section of cord to another. In order to allow quick attachment and release, a Ball attached to one section of cord interfaces with a Loop that is attached to a different section of cord (FIG. 1).

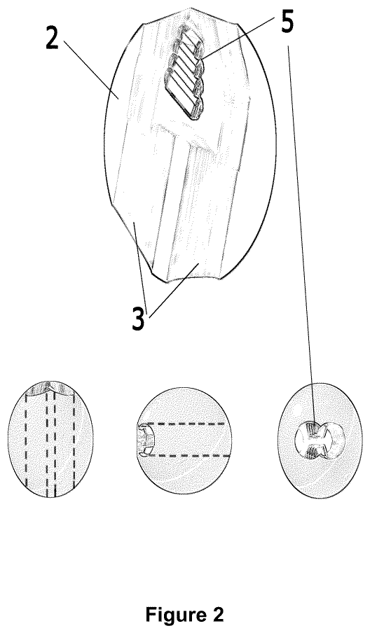

FIG. 2 shows a Ball (2) with a recessed catch (5) that is located between two holes (3), each of which allows passage of the cord through the Ball. The catch securely attaches the cord so that it cannot be removed from the ball by pulling on either exposed section of cord, as doing so would wedge the cord further into the catch. The cord can be detached from the Ball by removing it from the catch, which is done by either pushing on the work end of the cord (notoriously hard, but possible), pushing the recessed end of the cord back through its passage with a small rod, or by lifting the cord from the catch with a pin.

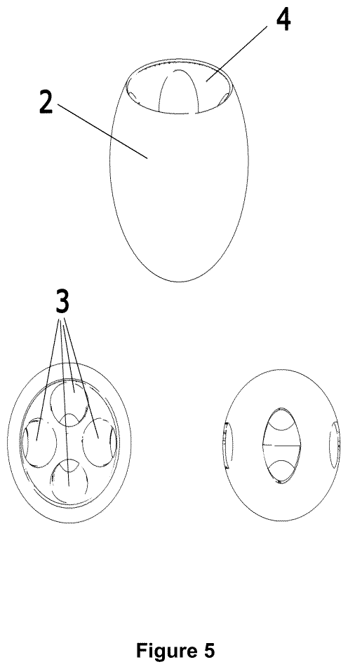

A Ball can be used to create a ring of cord by attaching two cord ends together. However, even though there are two passages in the Ball, passing two separate cords through the Ball does not permit either to be bound by the recessed catch. Therefore, multiple sections of cord require a Ball with two catches and four passages. The alternative implementation shown in FIG. 5 (2) replaces these catches with a cavity (4) in which the cords are tied together after passing through the holes in the ball (3). Removing these catches from the DoubleBall allows a Ball to have the same diameter as the two-passage Ball, which allows both to interface with a single version of the Loop.

### Fastening the Ball to the Loop

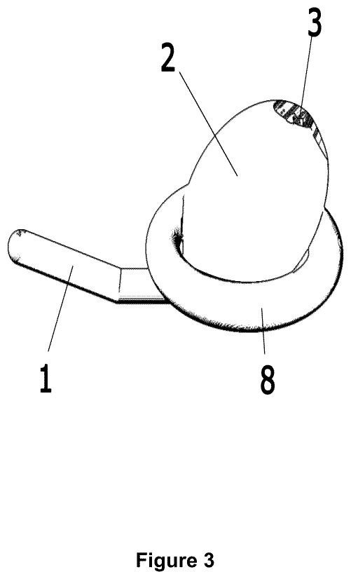

FIG. 3 shows a Ball (2) at the end of a cord (1) attached to a Loop (8). The cord (1) is bound to the ball by passing over the catch located at (3). The inner diameter of the Loop is only slightly larger than the outer diameter of the Ball, which implies that the spherical ball only narrowly passes through the loop. By elongating the ball along one axis, the radius in one direction exceeds the radius of the ring, which permits the Ball to pass through the ring in only one orientation. If the orientation of the Ball's elongation is in line with the passage of the cords into the Ball, the force on the cord must be perpendicular to the face of the Loop for the Ball to be detached. As this is not a natural configuration when the two cords attached to the Ball and Loop are under tension, it prevents accidental detachment of the Ball from the Loop.

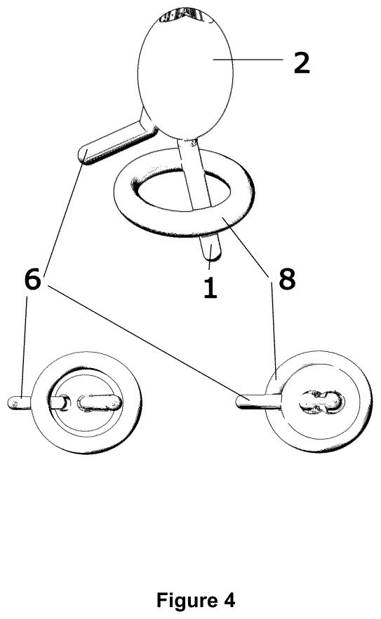

FIG. 4 shows the attachment of the Ball (2) at the end of a cord (1) to the Loop (8). The Ball is secured by leaving a short section of cord extending from its surface (6). Doing so prevents the Ball from passing back through the Loop unless the cord is passed first, since the Loop is not large enough to permit passage of both the Ball and the cord at the same time.

### Variations of the Ring

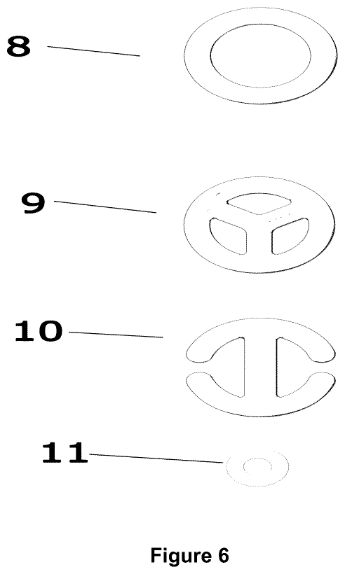

The mandate to attach a ring to a Ball or to different parts of a cord creates the four ring variants shown in FIG. 6: the Loop (8), the Bind (9), the Cleat (10), and the Eyelet (11). The use of one variation as opposed to another depends on what part of the cord is available: a second ball, a cord that requires tensioning, a cord midsection, or a length of cord along which the ring may travel, respectively.

The Loop (8) serves the purpose of binding a ball. For example, a DoubleLoop is capable of binding two Balls to one another, each of which binds a cord.

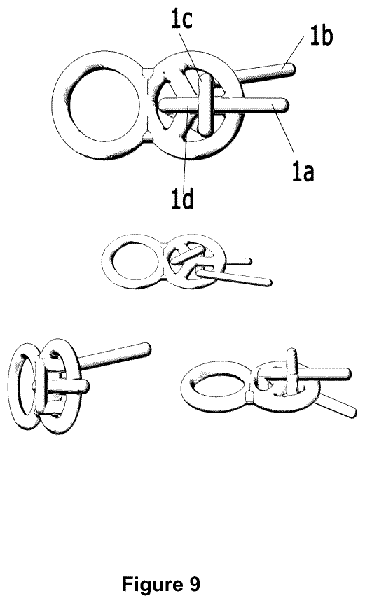

The Bind (9) is a ring or disc with three holes. The holes act as passages for the cord: two holes enable a turn of cord to protrude from the front side of the disc, and the third hole allows the cord to pass under that turn of cord. FIG. 9 shows a cord tied to the Bind that allows the cord to be tightened by pulling on the work end of the cord (1a) and prevents the cord from being loosened by pulling on the affixed end (1b). Therefore, tension must be removed from the binding turn of cord (1c) by lifting it off of the bound cord (1d), which is most easily done by first detaching the Ball from the Loop. It is also possible to place a ring or pull-tab under the binding turn of cord, which allows the user to pull on the binding cord even when the cord is under tension.

The Cleat (10) is a ring to which a section of cord may be tied. It can be used even when the end of the cord is unavailable (i.e. because it does not contain any holes that would require access to the end). It resembles a horn cleat with a ring-like shape, whose two horns enable the tying of a knot such as a cleat hitch.

The Eyelet (11) is a simple ring that attaches to a cord. It allows free travel along the length of the cord, and is therefore suited to applications where tensioning or tying are not appropriate.

### The LoopRing

The LoopRing is a type of DoubleRing that is composed of two rings, where the first ring is a Loop that can dynamically attach to a ball. As there are four variations of each ring, there are four variations of the LoopRing: the DoubleLoop, the LoopBind, the LoopCleat, and the LoopEyelet. For example, the LoopBind is composed of a Loop and a Bind; the Loop allows quick attachment and detachment, while the Bind allows a user to take up slack in the cord by pulling on the end of the cord that passes under a binding turn of that same cord (FIG. 1).

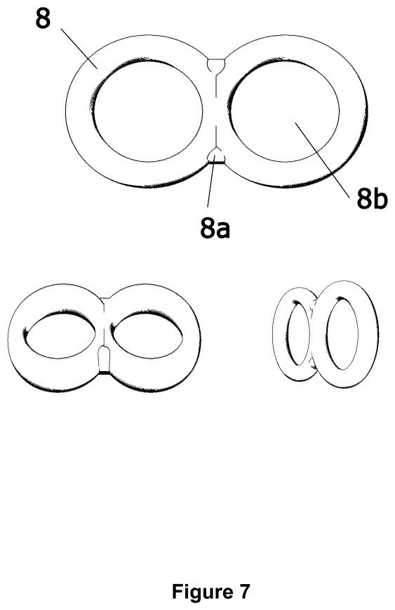

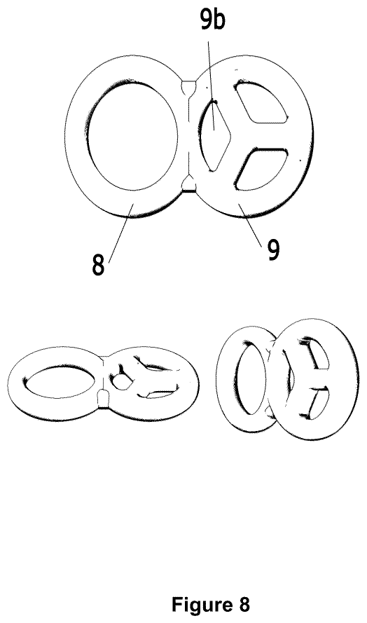

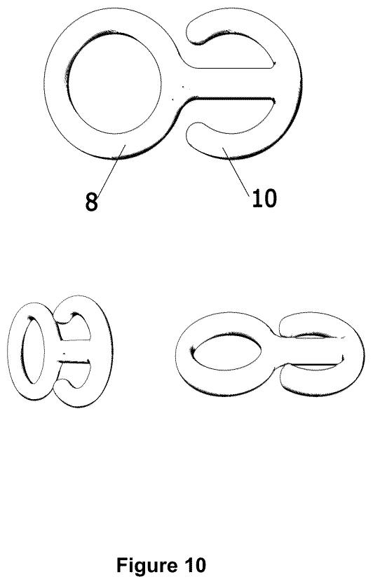

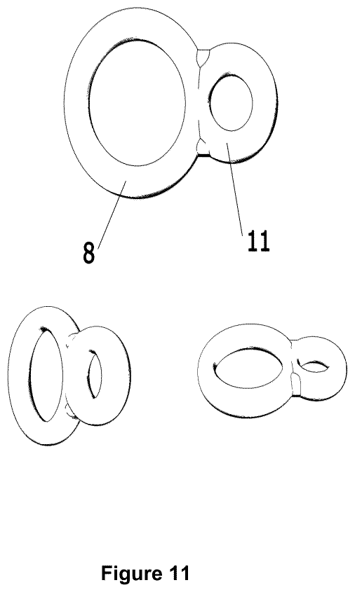

The use of one ring variation or another is determined by the application. To reiterate, if two balls are available, they may be joined with two attached loops (FIG. 7), a DoubleLoop which consists of two loops (8) reinforced at their point of contact (8a) that permit the passage of balls (8b). If tensioning is required, a LoopBind may be used (FIG. 8), which consists of a Loop (8) and a Bind (9). A LoopCleat may be used if tying to a section of cord is sufficient or there is no access to its end (FIG. 10), which consists of a Loop (8) and a Cleat (10). Finally, a LoopEyelet (FIG. 11), which consists of a Loop (8) and a Eyelet (11), can be used to hold a section of a cord if free travel along that length of cord is possible.

### The DoubleRing

The DoubleRing is composed of two permanently attached rings which maximally overlap without occluding either ring's inner surface. Since the two cords attached to the DoubleRing create stress on the point of contact between the two rings, reinforcing bars may be introduced to increase the area of contact (as in FIG. 7, 8a).

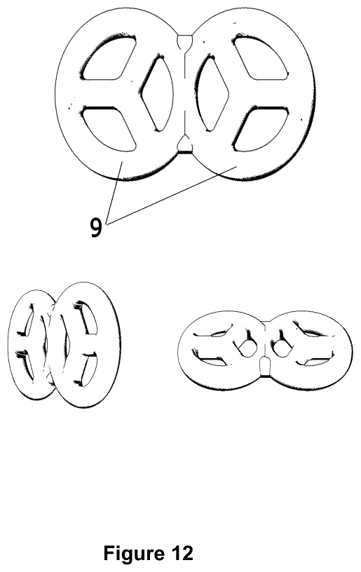

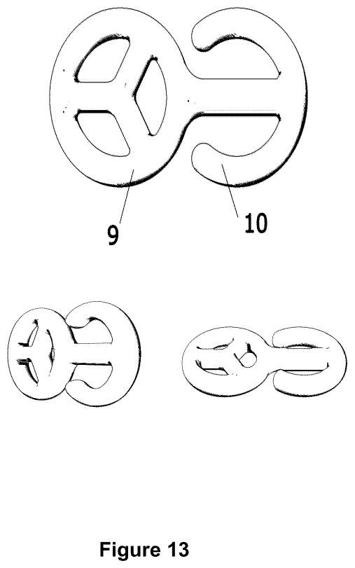

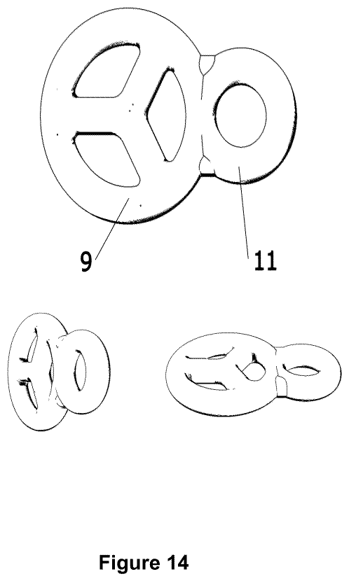

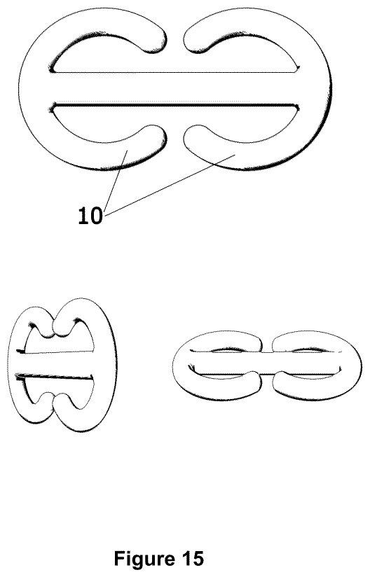

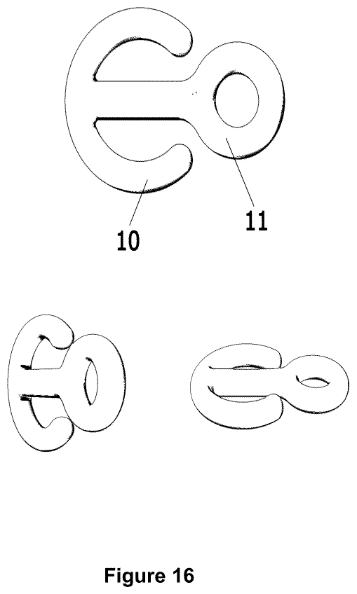

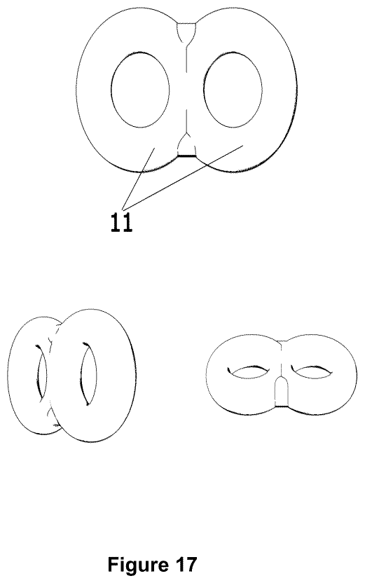

The four variations where one Ring is a Loop are described in the previous section, The LoopRing. There are six variations of the DoubleRing which do not incorporate a ball-sized Loop:
The DoubleBind (FIG. 12), consisting of two Binds (9).
The BindCleat (FIG. 13), consisting of a Bind (9) and a Cleat (10).
The BindEyelet (FIG. 14), consisting of a Bind (9) and an Eyelet (11).
The DoubleCleat (FIG. 15), consisting of two Cleats (10).
The CleatEyelet (FIG. 16), consisting of a Cleat (10) and an Eyelet (11).
The DoubleEyelet (FIG. 17), consisting of two Eyelets (11).

The DoubleBind is a DoubleRing which is formed of two Binds (9) as illustrated in FIG. 12. As the use of the common design elements (the Bind, the Cleat, and the Eyelet) has been explained previously, the remaining combinations are not described further.

If the attachment of multiple cords at a single locus is mandated by the application, additional rings may be added to the DoubleRing, which results in TripleRings, QuadrupleRings, etc.

### The BullsEye

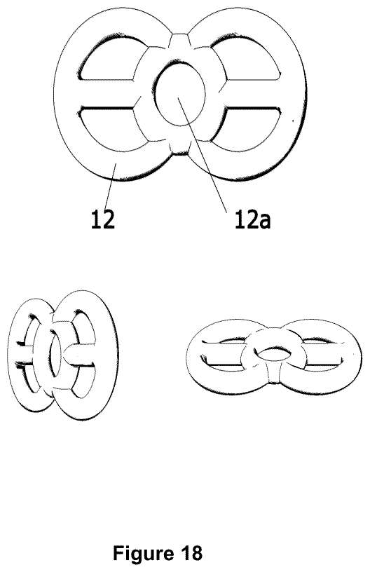

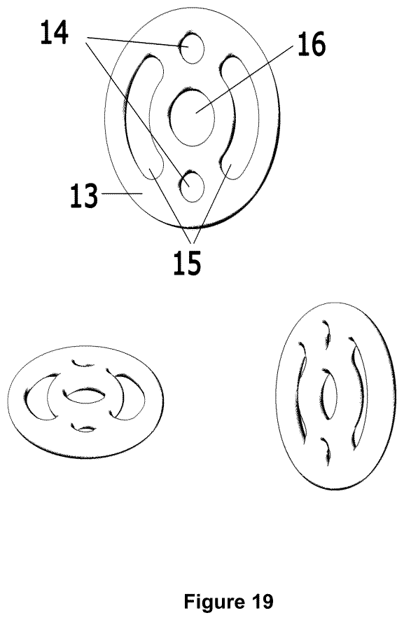

When two rings are combined, features of their essential topology may be combined: for example, the implementation of a DoubleBind shown in FIG. 18 (12) shares the central hole (12a) between the two binds since the cords sharing that hole do not interfere with one another. A further topological variation creates the BullsEye in FIG. 19 (13), in which all three passages (15,16) of each Bind are shared between both rings. In the implementation depicted here, the central passage (16) is shared and two radial passages (15) are formed by connecting the passages used to create the binding turn of cord on the face of the ring (the holes labeled as 14 are decorative in this implementation).

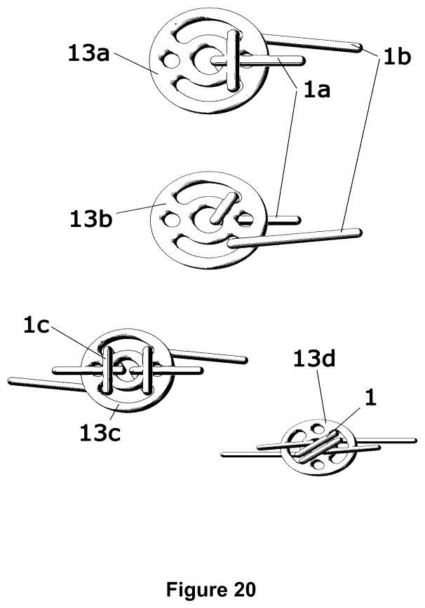

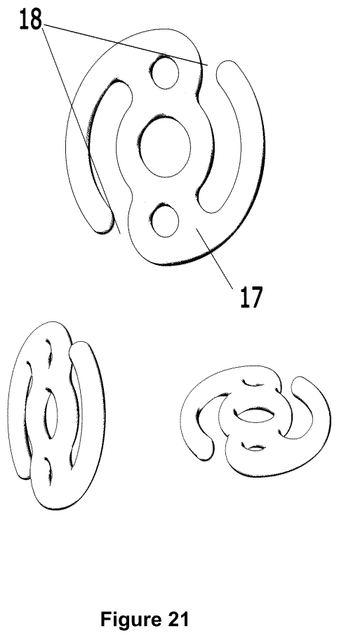

FIG. 20 illustrates how the BullsEye (13a,13b) is functionally similar to the DoubleBind in that it allows two sections of cord (1a,1b) to bind themselves and to create tension. However, the BullsEye is circular, which enables it to turn relatively easily even when attached to sections of cord. Further, turning the BullsEye in (13c) changes the location and orientation of the binding turn of cord (1c) as in (13d) such that it no longer creates a bind (1), thereby freeing the bound cords and removing any tension. Those unbound sections of cords may be removed from the BullsEye variation shown in FIG. 21 (17) via the holes in the radial passages (18).

1. A Ball and LoopRing device, comprising
a Ball with one or more cord passages and recessed catches; and
a LoopRing including
a circular Loop having a base and a central opening, the central opening sized to narrowly receive the Ball, and
a ring that is one of:
a Loop that allows a Ball to be attached,
a Bind having first, second, and third passages, the first and second passages enabling the creation of a binding turn of cord and the third passage allowing the cord to travel under that binding turn,
a Cleat having two semicircular horns that allow a section of a cord to be tied to the cleat, or
an Eyelet having an opening that receives a cord and that allows that cord to slide freely through the opening.

2. A DoubleRing device, comprising two permanently attached rings, where each of the rings is one of:
a Bind having first, second, and third passages, the first and second passages enabling the creation of a binding turn of cord and the third passage allowing the cord to travel under that binding turn,
a Cleat having two semicircular horns that allow a section of a cord to be tied to the cleat, or
an Eyelet having an opening that receives a cord and that allows that cord to slide freely through the opening.

3. A BullsEye device comprising a ring that has:
two semicircular passages that allow a cord to form a binding turn against the face of the device and that allow the device to be turned radially when attached to that cord, and
a central passage that allows the cord to pass from one side of the ring to the other,
wherein the cords forming the binding turn pass through alternate ends of the semicircular passages, such that turning the device will change the location of only one of those passages relative to the bound section of cord, thus removing the binding turn of cord from the section of cord passing underneath.

4. The Ball and LoopRing as in claim 1, wherein the Ball is oblong and slightly smaller than the Loop at its narrowest radius, which entails that the passage of the ball through the ring can occur in only one orientation.

5. The Ball and LoopRing as in claim 1, wherein the ring is a second Loop, which allows two balls to be attached to one another.

6. The Ball and LoopRing as in claim 1, wherein the ring is a Bind, which allows a ball to be tensioned against a section of cord.

7. The Ball and LoopRing as in claim 1, wherein the ring is a Cleat, which allows a ball to be securely attached to the midsection of a cord.

8. The Ball and LoopRing as in claim 1, wherein the ring is an Eyelet, which allows a ball to be attached to and travel along a section of cord.

9. The DoubleRing as in claim 2, wherein both rings are Binds, which allows two cord sections to be attached and tensioned against one another.

10. The DoubleBind as in claim 9, wherein the two holes that allow for the creation of the binding turn of loop are located on the inner portion of each ring.

11. The DoubleBind as in claim 10, wherein the inner holes that allow for the creation of a binding turn of loop are shared between the two cords.

12. The DoubleRing as in claim 2, wherein both rings are Cleats, which allows two cord midsections to be securely attached.

13. The DoubleCleat as in claim 12, wherein the middle axis has been removed to form a single ring formed of two semi-circular pairs of horns.

14. The DoubleRing as in claim 2, wherein both rings are Eyelets, which allows two unbound cord sections to be attached.

15. The DoubleRing as in claim 2, wherein one ring is a Bind and the other ring is a Cleat, which allows tensioning one section of cord to the midsection of another.

16. The DoubleRing as in claim 2, wherein one ring is a Bind and the other is an Eyelet, which allows tensioning one section of cord to an unbound section of another.

17. The DoubleRing as in claim 2, wherein one ring is a Cleat and the other is an Eyelet, which allows tensioning the midsection of one length of cord to an unbound section of another.

18. The DoubleRing as in claim 2, wherein the DoubleRing is generalized to multiple rings, which results in TripleRings, QuadrupleRings, etc.

19. The BullsEye as in claim 3, wherein the holes that allow the creation of a binding turn of cord are radial but are not shared between cords.

20. The BullsEye as in claim 3, wherein the passages allowing the binding turn are recesses that are open to the exterior of the outer ring rather than holes.
